(19) United States
(12) Patent Application Publication
(10) Pub. No.: US 2005/0152604 A1
(43) Pub. Date: Jul. 14, 2005

(54) Template matching method and target image area extraction apparatus

(75) Inventors: Shuji Kitagawa, Ibaraki (JP); Seiichiro Watanabe, Ibaraki (JP); Tadahiro Kuroda, Tokyo (JP); Kazuhiro Sato, Ibaraki (JP)

Correspondence Address: SILICON EDGE LAW GROUP LLP, 6601 KOLL CENTER PARKWAY, SUITE 245, PLEASANTON, CA, 94566, US

(73) Assignee: NuCORE Technology Inc.

(21) Appl. No.: 10/970,804

(22) Filed: Oct. 21, 2004

(30) Foreign Application Priority Data
Jan. 9, 2004 (JP) 004605/2004

(51) Int. Cl. G06K 9/62

(52) U.S. Cl. 382/209

(57) ABSTRACT

According to a template matching method, a matching value representing matching between a process area image and a target image is calculated by using the process area image in an arbitrary process area acquired from the edge image of an input image and template data representing the shape feature of the target image. The area of the target image in the input image is specified on the basis of the matching value. The template data is formed from positive points representing positions at which the edge of the target image exists in the process area and negative points representing positions at which no edge exists in the process area. The matching value is calculated in accordance with the positional relationship between the positive points, the negative points, and each edge present within the process area image. A target image area extraction apparatus is also disclosed.

### CROSS REFERENCE TO RELATED APPLICATION

This application is based on and hereby claims the benefit under 35 U.S.C. §119 from Japanese Application No. 004605/2004, filed on Jan. 9, 2004, in Japan, the contents of which are hereby incorporated by reference. This application is a continuation of Japanese Application No. JP2004-004605.

### TECHNICAL FIELD

The present invention relates to an image processing technique and, more particularly, to a technique of specifying the area of a target image in an input image on the basis of template data representing the shape feature of the target image and extracting information in the target image area.

### BACKGROUND

A template matching method has widely been used as a technique of specifying a target image in an input image on the basis of template data representing the feature of the target image. According to this method, as shown in FIG. 13 (prior art), a process area equal in size to template data T is scanned for each pixel in an input image. A matching value representing matching between the input image and template data for each process area image W is obtained. A desired target image area is specified on the basis of a process area having a maximum matching value.

The matching value is, for example, a normalized correlation coefficient. A normalized correlation coefficient R(x,y) is calculated on the basis of equation (1) using a pixel value W(x+i,y+j) of a pixel u(i,j) within the process area image W and a pixel value T(i,j) of a pixel u′(i,j) within the template data T:

$$R ( x , y ) = \frac{{\sum }_{i = 1}^{M} {\sum }_{j = 1}^{N} ( W ( x + 1 , y + j ) ) - {W}_{avg} ) \cdot ( T ( i , j ) - {T}_{avg} )}{\sqrt{{\sum }_{i = 1}^{M} {\sum }_{j = 1}^{N} {( W ( x + 1 , y + j ) - {W}_{avg} )}^{2}} + \sqrt{{\sum }_{i = 1}^{M} {\sum }_{j = 1}^{N} {( T ( i , j ) - {T}_{avg} )}^{2}}} \qquad ( 1 )$$

where Wavg is the average pixel value in the process area, and Tavg is the average pixel value of the template. The normalized correlation coefficient comes closer to 1 for a higher correlation between the two images and −1 for a lower correlation.

The template matching method is employed in, for example, an electronic component board mounting apparatus. In an apparatus of this type, the image of a component chucked for mounting on a board is sensed by an image sensing device such as a camera. The chucking position and direction are recognized on the basis of the above-mentioned template matching method. By correcting the position and direction, the component can be arranged and mounted on the board at high precision.

Detailed recognition of the chucking position and direction of a component is executed by the following method. First, vertical and horizontal projection distributions are created from a component image in a sensed image. A rough position and direction of a target component are recognized from the projection distributions. Then, an area where the four corners of the target component exist is predicted from the rough position information and direction information. An accurate component position is recognized by template matching using a template having the four-corner shape in the area.

Various techniques have conventionally been proposed for a higher area extraction precision of template matching.

In a first example of the prior art, a technique such as Japanese Patent Laid-Open No. 8-315147 has been proposed. This template matching method defines a mask area that is set in template data so as to process the mask area as invalid data in calculation of a matching value. With this template, a small angle shift of the template does not influence correlation calculation for obtaining a matching value.

In a second example of the prior art, an apparatus has been proposed that extracts a person's face area by using the above-described template matching method (see, e.g., Tomoharu Nagao, “Introduction to Image Processing by C Language”, Shokodo, Nov. 20, 2000, pp. 204-211). This apparatus specifies a person's face area in an image by searching a continuous tone image containing the person's face area by using a mosaic face template as shown in FIG. 14 (prior art).

In a third example of the prior art, a technique has been proposed for creating the edge image of a skin color-extracted area in a skin color-extracted image obtained by extracting only skin color pixels corresponding to a preset skin color from a digital color image containing a person's face area, searching the image by template matching using an elliptic template, and extracting the person's face area.

These prior art methods, however, suffer from long processing times because of the large number of templates necessary to extract a target image area. In addition, erroneous extraction readily occurs under the influence of noise.

In the first prior art method, the vertical and horizontal projection distributions of a component image serving as a target image must be created from a sensed image in order to recognize the component position. The number of templates increases because both the target image and template data use sensed monochrome binary images or continuous tone images. This prolongs the correlation calculation time in a matching process.

The second prior art method adopts a mosaic face template. Also in this case, both the input image and template data use monochrome continuous tone images, and the number of templates increases because template matching with an entire face within the image is executed. This leads to a large memory capacity for storing templates and a long template matching process time. In a method of searching for a face area by utilizing continuous tone information of an image, a change in face direction within the image greatly influences the recognition rate in, for example, an image in profile.

In the third prior art method, the edge image of a skin color-extracted area is created from a skin color-extracted image obtained by extracting only skin color pixels corresponding to a preset skin color from a digital color image containing a person's face area. The image is searched by template matching using an elliptic template, and the face area is extracted. According to this method, however, the elliptic edge template may match the edge of an area, other than the face area, where the color is close to the skin color of the person.

When the third prior art method is actually applied to an image sensed by a digital camera or the like, a face template 302 matches a face area 301, as shown in FIG. 15 (prior art). If an object such as a tree trunk whose surface is rough with a color close to the skin color exists, many edges appear as noise in the edge image of a skin color-extracted area. A face template 303 matches the area containing such noise.

When a target angle position having a specific angle is detected from the edge image of a triangle, an angle template 312 matches a desired target angle 311, as shown in FIG. 16 (prior art). However, an angle template 313 matches a wrong area defined by two triangles.

### SUMMARY

The present invention has been made to overcome the conventional drawbacks, and has as its object to provide a template matching method and target image area extraction apparatus capable of extracting a target image area at high precision by using a template of a very small data amount.

To achieve the above object, a template matching method calculates a matching value representing matching between a process area image and a target image by using the process area image in an arbitrary process area acquired from an edge image of an input image and template data representing a shape feature of the target image. The method specifies an area of the target image in the input image on the basis of the matching value. The template data is formed from positive points representing positions at which an edge of the target image exists in the process area and negative points representing positions at which no edge exists in the process area. The matching value is calculated based on a positional relationship between the positive points, the negative points, and each edge present within the process area image.

A target image area extraction apparatus stores an edge image representing a contour of an object in an input image. The apparatus specifies a process area in the input image as a specified process area that contains a target image, and the apparatus extracts the target image from the input image. The apparatus comprises a template data holding unit, a template coordinate calculation unit, a matching calculation unit, a target area specifying unit, and a target area information extraction unit.

The template data holding unit stores template data representing a shape feature of a target image to be extracted. The template coordinate calculation unit performs coordinate transformation on the template data based on matching candidate information and generates new template data. The matching calculation unit calculates a matching value that matches a process area to the new template data generated by the template coordinate calculation unit. The target area specifying unit specifies the process area associated with the matching value as an area containing the target image when the matching value exceeds a predetermined reference value.

The target area information extraction unit outputs area information for a target image area based on the new template data and on a coordinate position of the specified process area. The new template data are derived from positive points representing positions at which an edge of the target image exists within the process area and negative points representing positions at which no edge of the target image exists within the process area. The matching calculation unit calculates the matching value based on a positional relationship between the positive points, the negative points, and each edge present within the process area.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a block diagram showing the arrangement of a target image area extraction apparatus according to a first embodiment of the present invention.

FIG. 2 is a view showing an example of the structure of template data (face contour).

FIG. 3 is a view showing another example of the structure of template data (face contour).

FIGS. 4A and 4B are views showing a template data conversion process.

FIG. 5 is a flowchart showing a matching value calculation process according to the first embodiment of the present invention.

FIG. 6 is a flowchart showing a template matching process according to the first embodiment of the present invention.

FIG. 7 is a view showing an extraction result (face area) by the target image area extraction apparatus according to the first embodiment of the present invention.

FIG. 8 is a view showing an extraction result (angle area) by the target image area extraction apparatus according to the first embodiment of the present invention.

FIG. 9 is a block diagram showing the arrangement of a target image area extraction apparatus according to the second embodiment of the present invention.

FIG. 10 is a block diagram showing an example of the arrangement of a matching candidate output unit according to the second embodiment of the present invention.

FIG. 11 is a view showing an example of the structure of an individual (chromosome information).

FIG. 12 is a flowchart showing a matching candidate information generation process according to the second embodiment of the present invention.

FIG. 13 (prior art) is a view showing a conventional template matching process.

FIG. 14 (prior art) is a view showing an example of the structure of conventional template data (mosaic face template).

FIG. 15 (prior art) is a view showing an extraction result (face area) by a conventional target image area extraction technique.

FIG. 16 (prior art) is a view showing an extraction result (angle area) by the conventional target image area extraction technique.

### DETAILED DESCRIPTION

Reference will now be made in detail to some embodiments of the invention, examples of which are illustrated in the accompanying drawings.

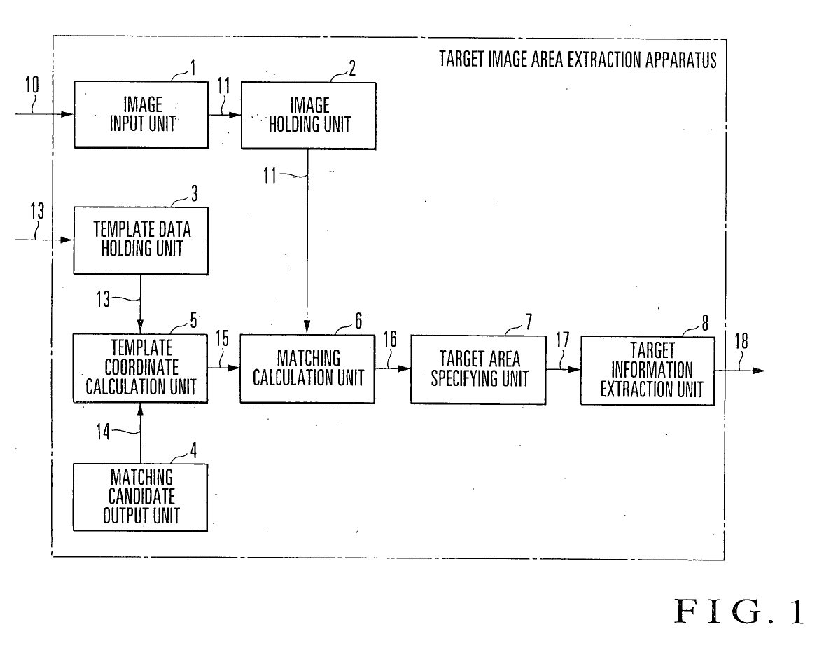

FIG. 1 shows the arrangement of a target image area extraction apparatus according to a first embodiment of the present invention. The target image area extraction apparatus operates according to a template matching method that is also described with reference to FIG. 1.

The target image area extraction apparatus is comprised of a computer, which performs image processing as a whole. Various functional means are implemented in cooperation with a program prepared in advance and hardware including a microprocessor (for example, a CPU or a DSP (Digital Signal Processor)) and its peripheral circuit, or by only hardware.

The functional means are an image input unit 1, an image holding unit 2, a template data holding unit 3, a matching candidate output unit 4, a template coordinate calculation unit 5, a matching calculation unit 6, a target area specifying unit 7, and a target area information extraction unit 8.

In the template matching method according to the first embodiment, process area images sequentially acquired from the edge image of an input image are compared with template data representing the shape feature of a target image. A desired target image area is extracted from the edge image of the input image on the basis of a matching value representing matching between each process area image and the template data. At this time, the template matching method uses positive points representing edge positions within the target image and negative points representing positions at which no edge exists. The matching value is calculated in accordance with the positional relationship between positive points, negative points, and each edge present within the process area image. The target image area extraction apparatus according to the first embodiment extracts target area information such as the position, rotation angle, and size of a desired target image area in the input image by the template matching method.

Each functional means will be explained with reference to FIG. 1. The image input unit 1 receives an input image 10 sensed by an image sensing device such as a camera, via a communication line or recording medium or directly from the image sensing apparatus. The image input unit 1 performs an edge extraction process to generate and output an edge image 11 representing the contour of an object. For example, when a person's face area is to be extracted, the input image 10 formed from a digital color image undergoes extraction of skin color pixels, noise removal, and edge extraction using a differential filter. The obtained edge image is binarized and subjected to a gradation process using a low-pass filter, thereby generating the edge image 11 having a predetermined number of gray levels such as seven gray levels (three bits) or three gray levels (two bits). These image processes can be known processes. Generally in the obtained edge image 11, the edge is expressed by black pixels with a large gray value, and an area free from any edge is expressed by white pixels with a small gray value.

The image holding unit 2 is comprised of a memory, a hard disk, or the like, and stores and holds the edge image 11 generated by the image input unit 1.

The template data holding unit 3 is comprised of a memory, a hard disk, or the like, and holds template data 13 input in advance as template data representing the shape feature of a target image to be extracted from the input image 10. The template data 13 is made up of positive points representing edge positions in a target image and negative points representing positions at which no edge exists. In practice, the template data 13 is formed from coordinate information representing the positions of positive and negative points.

The matching candidate output unit 4 selects at random conversion parameters such as the center position, rotation angle, and enlargement ratio used to make the template data 13 match the edge image 11. The matching candidate output unit 4 outputs the selected conversion parameters as matching candidate information 14.

The template coordinate calculation unit 5 transforms the coordinates of the template data 13 read out from the template data holding unit 3 on the basis of the matching candidate information 14 from the matching candidate output unit 4. The template coordinate calculation unit 5 outputs the converted template data 13 as new template data 15.

The matching calculation unit 6 performs a matching value calculation process (described below) for the edge image 11 read out from the image holding unit 2 by using the template data 15 from the template coordinate calculation unit 5. The matching calculation unit 6 calculates matching values for respective process areas sequentially set in the edge image 11, and outputs the matching values as calculation results 16.

As the matching value calculation process, the matching calculation unit 6 calculates a matching value in accordance with the positional relationship between positive or negative points set by the template data 15 and an edge present within the edge image 11.

The target area specifying unit 7 compares the matching value contained in the calculation result 16 from the matching calculation unit 6 with a preset reference value. When a matching value exceeding the reference value is detected, the target area specifying unit 7 specifies a process area having the matching value as a position at which a desired target image exists, and outputs process area information 17 representing the process area.

The target area information extraction unit 8 outputs target area information 18 representing the position, angle, size, and the like of a desired target image area as information within the target image area in the input image 10 on the basis of the template data 15 and coordinate information representing the process area designated by the process area information 17 from the target area specifying unit 7.

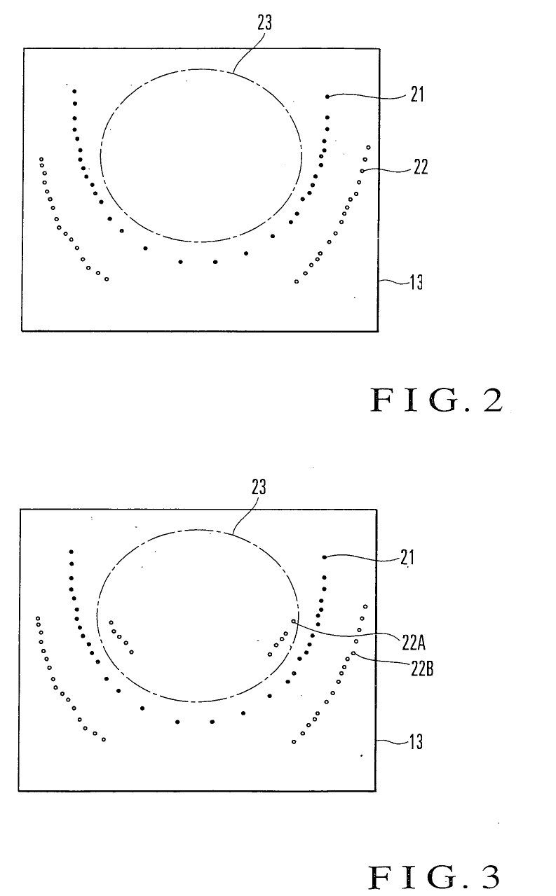

The structure of template data used in the first embodiment will now be explained with reference to FIGS. 2 and 3. FIG. 2 shows an example of the structure of template data 13 used in the first embodiment. FIG. 3 shows another example of the structure of the template data 13 used in the first embodiment.

For example, when a face area is to be extracted from an input image, positive points 21 are arranged as feature points along an edge representing a person's face contour, for example, a semi-elliptical chin contour, as represented by the template data 13 in FIG. 2. Negative points 22 are arranged outside an area 23 formed by the positive points 21, for example, outside the face contour.

In the template data 13 of FIG. 3, similar to FIG. 2, the positive points 21 are arranged as feature points along an edge representing a person's face contour. Negative points 22A are arranged within the area 23 formed by the positive points 21, and negative points 22B are arranged outside the area 23.

Feature points provided by the positive points 21 and the negative points 22, 22A, and 22B are designated by coordinate information in a template area of a predetermined size equal to a process area.

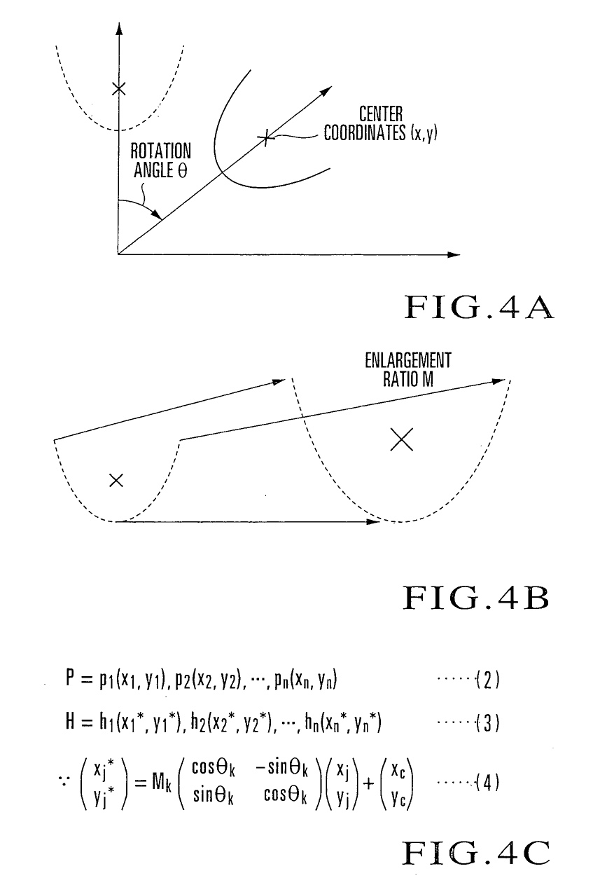

A template data conversion process used in the first embodiment will now be explained with reference to FIGS. 4A and 4B. FIGS. 4A and 4B show the template data conversion process used in the first embodiment. FIG. 4A shows conversion associated with the rotation angle and center coordinates. FIG. 4B shows conversion associated with the enlargement ratio.

The template coordinate calculation unit 5 converts the template data 13 on the basis of the matching candidate information 14 from the matching candidate output unit 4. The matching candidate information 14 contains center coordinates (x,y), a rotation angle θ, and an enlargement ratio M as conversion parameters for the template data 13.

As shown in FIG. 4A, the center position (x,y) is a conversion parameter that designates coordinates serving as the reference of a feature point group including positive and negative points, for example, the coordinates of the chin of a person's face in the matching value calculation process with the edge image 11. New template data centered on the designated coordinates (x,y) is obtained.

The rotation angle θ is a conversion parameter representing the rotation amount of the feature point group. For example, when the template data 13 represents a face contour, new template data prepared by rotating the feature point group representing the contour by θ about predetermined origin coordinates is obtained.

As shown in FIG. 4B, the enlargement ratio M is a conversion parameter representing the degree of enlargement/reduction of the template data 13. For example, when the template data 13 represents a face contour, new template data prepared by enlarging/reducing the feature point group representing the contour at the enlargement ratio M is obtained.

A point sequence P of the feature point group forms the template data 13, i.e., pieces of coordinate information p1 to pn are given in advance by equation (2):
P=p1(x1,y1), p2(x2,y2), . . . , pn(xn,yn) (2)

The point sequence P undergoes affine transformation using equations (3) and (4) on the basis of the conversion parameter:
H=h1(x1*,y1*), h2(x2*,y2*), . . . , hn(xn*,yn*) (3)

$$∵ ( \begin{matrix}{x}_{j}^{*} \\ {y}_{j}^{*}\end{matrix} ) = {M}_{k} ( \begin{matrix}cos {θ}_{k} & - sin {θ}_{k} \\ sin {θ}_{k} & cos {θ}_{k}\end{matrix} ) ( \begin{matrix}{x}_{j} \\ {y}_{j}\end{matrix} ) + ( \begin{matrix}{x}_{c} \\ {y}_{c}\end{matrix} ) \qquad ( 4 )$$

New coordinate information obtained by transformation represents a point sequence H of the feature point group of the template data 15, for example, pieces of coordinate information h1 to hn.

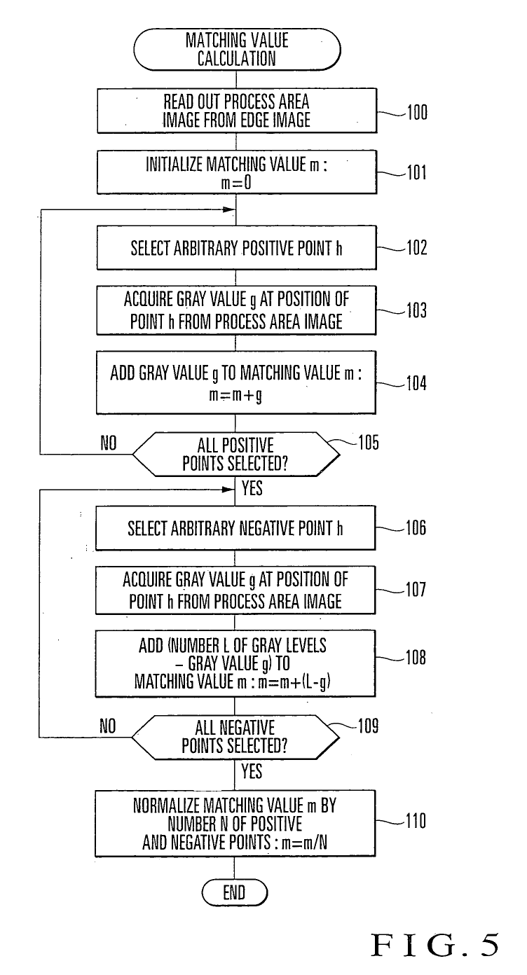

A matching value calculation method according to the first embodiment will now be described with reference to FIG. 5. FIG. 5 shows the matching value calculation process according to the first embodiment of the present invention. In the following description, the image of one process area set in the edge image 11 and the template data 15 are used to calculate a matching value between the image and the template data 15.

In a step 100, the matching calculation unit 6 reads out image data of a process area from the edge image 11 and, in step 101, sets a matching value m to an initial value (m=0).

In a step 102, an arbitrary positive point h is selected and read out from the template data 15. A gray value g of a pixel at a position corresponding to coordinate information (hx,hy) of the positive point h in the process area image is acquired and calculated as an evaluation value for the positive point h (step 103). The evaluation value g is added to the matching value m (step 104).

In a decision step 105, it is determined whether all positive points have been selected. If all positive point have not yet been selected (NO in step 105), steps 102 to 104 are repetitively executed for all positive points h.

If all positive points h have been selected and the positive point evaluation process ends (YES in step 105), an arbitrary negative point h is read out from the template data 15 (step 106). The gray value g of a pixel at a position corresponding to coordinate information (hx,hy) of the negative point h in the process area image is acquired. A value L-g is calculated as an evaluation value corresponding to the negative point h by subtracting the gray value g from the number L of gray levels of the edge image 11 (step 107). The evaluation value L-g is added to the matching value m (step 108).

Steps 106 to 108 are repetitively executed for all negative points h (NO in step 109). If all negative points h have been selected and the negative point evaluation process ends (YES in step 109), the obtained matching value m is divided by the number N of positive and negative points to calculate a normalized matching value (step 110). A series of matching value calculation processes end.

The obtained matching value m takes a value of 0 to 1, and a larger value represents higher matching between a process area image and the template data 15.

In this manner, the first embodiment adopts template data formed from positive points representing the edge positions of a target image and negative points representing positions at which no edge of the target image exists. The matching value is calculated in accordance with the positional relationship between positive points, negative points, and each edge present within the process area image. The edge position of a target image can be searched for with a template of a very small data amount. Also, an edge other than that of the target image can be recognized, and the target image area can be extracted at high precision.

Compared to the prior art that uses a plurality of templates or a continuous tone image as template data, the process time taken for the matching value calculation process can be greatly shortened, and the storage capacity for holding template data can be greatly reduced.

In calculating a matching value, evaluation values are calculated for positive and negative points on the basis of the gray values of pixels of a process area image that correspond to the positions of the positive and negative points, and the matching value is calculated from these evaluation values. The matching value can therefore be calculated by only an arithmetic process for the gray values of pixels of the process area image, simplifying the process.

More specifically, the gray value of a pixel corresponding to the position of a positive point is calculated as an evaluation value for each positive point. A value obtained by subtracting the gray value of a pixel corresponding to the position of a negative point from the number of gray levels of an edge image is calculated as an evaluation value for each negative point. The matching value is calculated from the sum of these evaluation values. Calculation of the matching value can be implemented by only the addition/subtraction process, and the matching value can be calculated within a very short time.

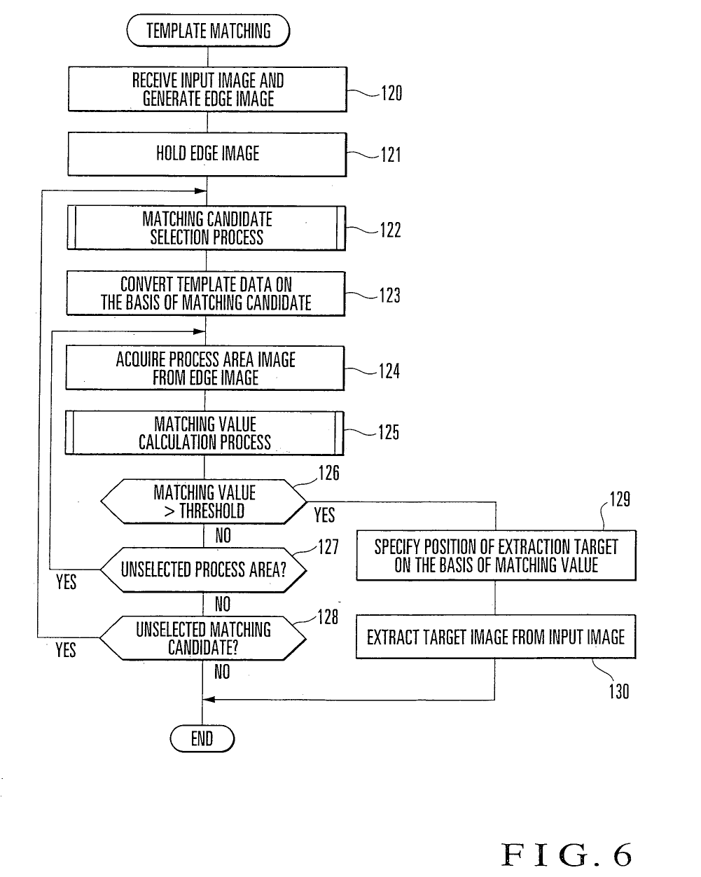

A template matching process will now be explained as the operation of the target image area extraction apparatus according to the first embodiment of the present invention will be described with reference to FIG. 6.

FIG. 6 shows the template matching process according to the first embodiment of the present invention. The image input unit 1 receives the input image 10 to be processed, and generates the edge image 11 (step 120). The edge image 11 is held in the image holding unit 2 (step 121).

The matching candidate output unit 4 selects conversion parameters such as the center position, rotation angle, and enlargement ratio by a matching candidate selection process using a random generation function or the like, and outputs the selected conversion parameters as the matching candidate information 14 (step 122).

The template coordinate calculation unit 5 converts the template data 13 read out in advance from the template data holding unit 3 on the basis of the matching candidate information 14, and outputs the converted template data 13 as the template data 15 (step 123).

The matching calculation unit 6 reads out a process area image corresponding to an arbitrary process area from the edge image 11 of the image holding unit 2 (step 124), and performs the above-described matching value calculation process of FIG. 5 by using the template data 15 (step 125). The matching calculation unit 6 outputs, as the calculation result 16, a matching value obtained for each process area image by the matching value calculation process, together with area information representing the process area.

The target area specifying unit 7 compares the matching value contained in the calculation result 16 from the matching calculation unit 6 with a preset reference value (step 126). If no matching value exceeding the reference value is detected (NO in step 126) and an unprocessed area exists (YES in step 127), the flow returns to step 124 and shifts to the matching process for a new process area.

If no unprocessed area exists and the matching process using the template data 15 ends (NO in step 127), and an unprocessed matching candidate exists, for example, the number of matching candidates used does not reach a predetermined number (YES in step 128), the flow returns to step 122 and shifts to a generation process for the template data 15 using a new matching candidate.

If no unprocessed matching candidate exists, the number of matching candidates used reaches the predetermined number, and all matching candidates have undergone the matching process (NO in step 128), no desired target image can be specified in the input image 10, ending a series of template matching processes.

If a matching value exceeding the reference value is detected (YES in step 126), the target area specifying unit 7 specifies a process area having the matching value as an area containing a desired target image area, and outputs the process area information 17 representing the process area (step 129).

The target area information extraction unit 8 grasps the reference position of a process area image in the input image 10 on the basis of the process area information 17 from the target area specifying unit 7. The target area information extraction unit 8 also grasps a rectangular area surrounded by, for example, the leftmost, uppermost, rightmost, and lowermost points of the process area on the basis of the template data 15. The target area information extraction unit 8 generates the target area information 18 from these pieces of information, and outputs it (step 130), ending a series of template matching processes.

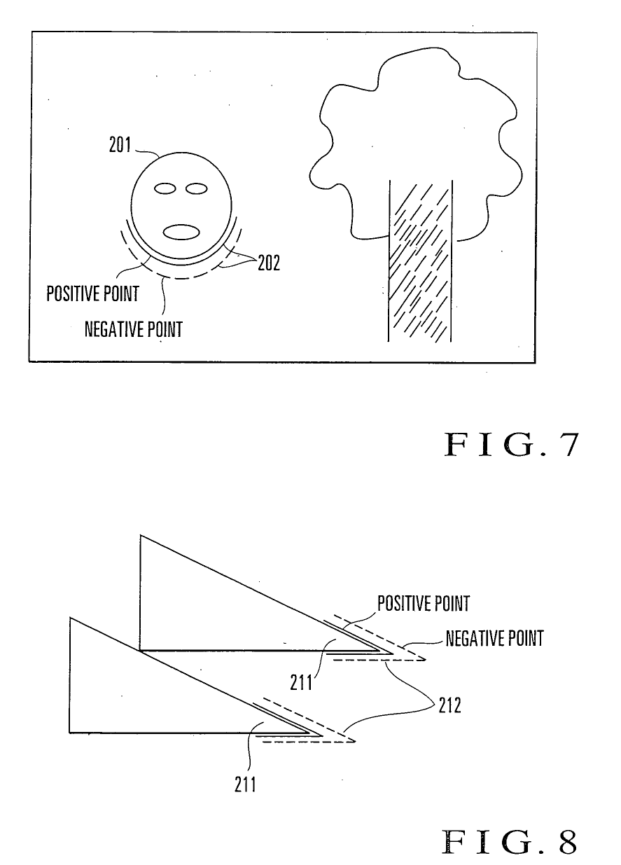

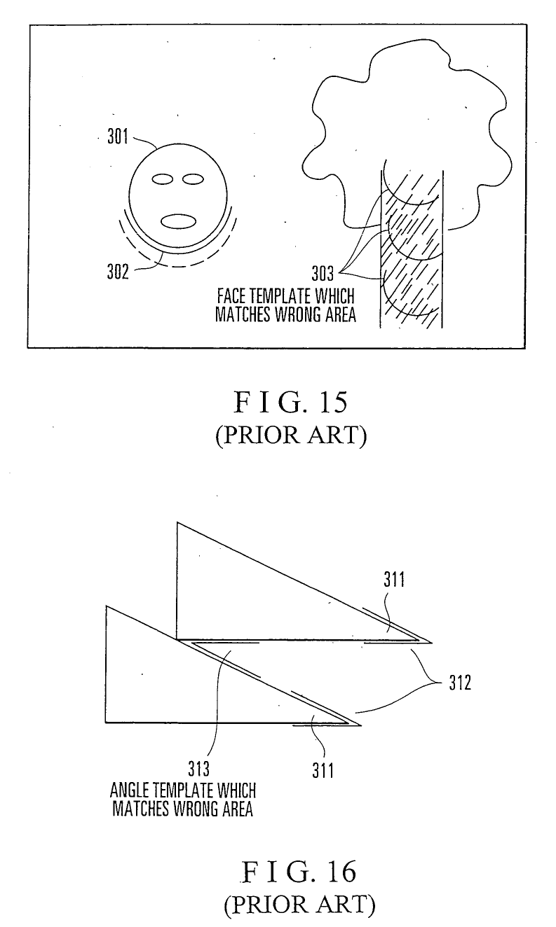

FIG. 7 shows the extraction result of a face area according to the first embodiment. In the result of FIG. 15 by the above-mentioned prior art, the color of a tree trunk is close to the skin color, and the surface is rough. Thus, many edges appear as noise in the edge image of a skin color-extracted area, and a face template 303 undesirably matches the image of the tree trunk. According to the first embodiment, template data is made up of positive and negative points. The template does not match noise, and a face template 202 made up of positive and negative points correctly matches a face area 201, as shown in FIG. 7.

FIG. 8 shows the extraction result of an angle area according to the first embodiment. In the result of FIG. 16 by the above-mentioned prior art, an angle template 313 undesirably matches a wrong area defined by two triangles. According to the first embodiment, template data is made up of positive and negative points. As shown in FIG. 8, an extra edge defined by two triangles, i.e., an edge other than that of a target image is recognized from negative points, and the difference from a desired angle area is considered in the matching value. An angle template 212 formed from positive and negative points correctly matches a desired angle area 211.

In the first embodiment, a plurality of types of parameters used for coordinate transformation of positive and negative points of template data are generated at random as matching candidate information. The coordinates of the positive and negative points of the template data are transformed on the basis of the matching candidate information to generate new template data used to calculate a matching value. Even when many types of target images with different positions, rotation angles, or sizes may be contained in the input image 10, a desired target image area can be efficiently extracted from the large search space on the basis of template data of a small amount.

In the above description, examples of the structure of template data are illustrated in FIGS. 2 and 3, but the present invention is not limited to them. For example, template data may be prepared by arranging positive points on the edge of a target image and arranging negative points so as not to overlap another edge of the target image present around the edge. This template data can prevent a case in which an edge of the target image that is not used to specify the target image on the basis of positive points is recognized as an edge other than that of the extracted image on the basis of negative points. Template matching can be achieved at higher precision.

At this time, negative points may be additionally arranged within an area formed by the edge of a target image. When other edges of the target image hardly exist within the area, erroneous recognition based on the negative points can be avoided, and an edge other than that of the extracted image can be recognized on the basis of the negative points. The matching precision can be further increased by only adding a relatively small number of negative points.

Alternatively, negative points may be additionally arranged outside an area formed by the edge of a target image. When other edges of the target image rarely exist outside the area, erroneous recognition based on the negative points can be avoided, and an edge other than that of the extracted image can also be recognized on the basis of the negative points. The matching precision can be further increased by only adding a relatively small number of negative points.

As other template data, negative points may be arranged around positive points along a shape formed by the positive points arranged on the edge of a target image. The edge of the target image can be efficiently specified by small numbers of positive and negative points, and a template of a small data amount can effectively match the edge of the target image.

As still other template data, when positive points are to be arranged in an area where the edge of a target image exists, they may be arranged at a density corresponding to the ratio at which the edge appears in the area. The number of positive points can be adjusted in accordance with the amount of an edge to be specified by the positive points, and a template of a small data amount can effectively match the edge of the target image.

As still other template data, when negative points are to be arranged in an area around the edge of a target image, they may be arranged at a density corresponding to the ratio at which an edge other than that of the target image appears in the area. The number of negative points can be adjusted in accordance with the amount of another edge to be recognized by the negative points, and a template of a small data amount can effectively match the edge of the target image.

When the template matching method or target image area extraction apparatus according to the first embodiment is used to extract the area of a person's face image from an input image, the target image is the person's face image, and the edge of the target image is an edge representing the lower contour of the person's face image. The area of the person's face image can be efficiently extracted at high precision by using the lower contour of the person's face image that provides a relatively clear edge.

The template data is face template data having positive points representing positions at which the edge expressing the lower contour of the person's face image exists and negative points representing positions at which the edge expressing the lower contour of the person's face image does not exist. Matching of the face template data with an area other than the person's face image can be avoided, and the area of the person's face image can be efficiently extracted at high precision.

At this time, a semi-elliptical shape may be adopted as the edge representing the lower contour of the person's face image, and can easily form the face template data. The number of building points of the template can be decreased in comparison with the use of a mosaic face template or an elliptic template which imitates the contour edge of an entire face. Accordingly, the matching process time can be shortened.

Further, positive points in face template data may be arranged at a high density in the cheek contour area of the person's face image and a low density in the chin contour area of the person's face image. Even when the edge of the chin contour on which an edge other than that of the person's face image exists at high possibility is not clear, the area of the person's face image can be extracted at high precision.

Also, negative points may be arranged at a high density in the cheek contour area of the person's face image within an area outside an area formed by the edge representing the lower contour of the person's face image, and a low density in the chin contour area of the person's face image. When an edge image containing a face area is created by extracting the edge of a skin color area from a color image, but the chin and neck overlap each other and the chin edge is not clear, the person's face area can be extracted at high precision.

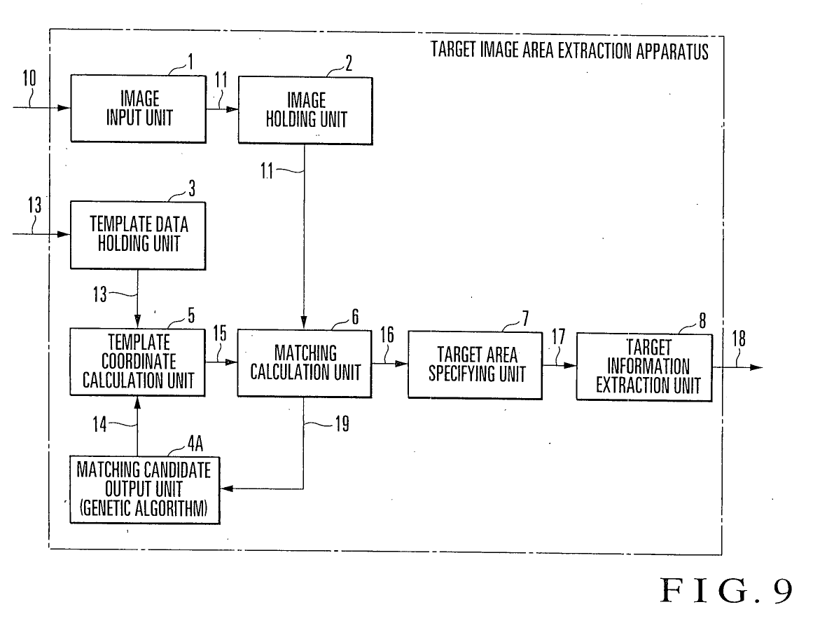

FIG. 9 shows the arrangement of the target image area extraction apparatus according to a second embodiment of the present invention. The target image area extraction apparatus operates according to a second template matching method that is also described with reference to FIG. 9.

The first embodiment of the target image area extraction apparatus selects a matching candidate at random. The second embodiment selects a matching candidate on the basis of a genetic algorithm (GA).

The target image area extraction apparatus shown in FIG. 9 has the same arrangement as that described above, except that a matching candidate output unit 4A and matching calculation unit 6A replace the matching candidate output unit 4 and matching calculation unit 6 in FIG. 1. The target image area extraction apparatus uses the same template data as that described above. The same reference numerals denote the same or similar parts in FIG. 1.

The matching candidate output unit 4A selects at random conversion parameters such as the center position, rotation angle, and enlargement ratio used to make template data 13 match an edge image 11 on the basis of the genetic algorithm. The matching candidate output unit 4A outputs the selected conversion parameters as matching candidate information 14.

The matching calculation unit 6A performs a matching value calculation process (described below) for the edge image 11 read out from an image holding unit 2 by using template data 15 from a template coordinate calculation unit 5. The matching calculation unit 6A calculates matching values for respective process areas sequentially set in the edge image 11, and outputs the matching values as calculation results 16 together with area information of the process areas. At this time, the matching calculation unit 6A outputs the obtained matching values to the matching candidate output unit 4A in order to adjust the genetic algorithm.

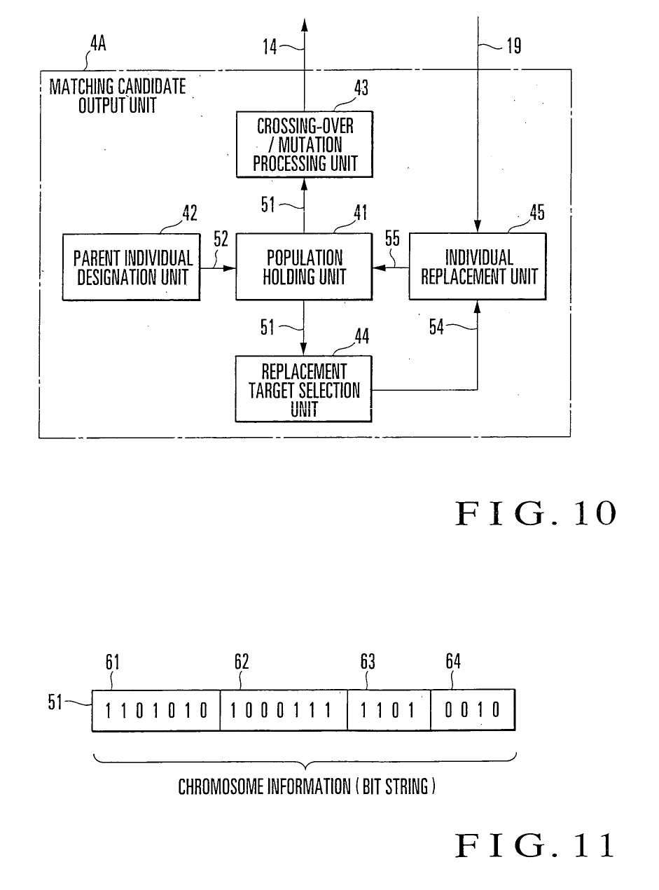

A matching candidate selection process based on the genetic algorithm by the matching candidate output unit 4A according to the second embodiment will now be explained with reference to FIGS. 9 and 10. FIG. 9 shows an example of the arrangement of the matching candidate output unit 4A. FIG. 10 shows an example of the structure of chromosome information used in the genetic algorithm.

The genetic algorithm is a method of obtaining an optimal solution from existing information by employing in an information processing technique the genetic mechanism of a living being, for example, crossing-over of generating a new individual from a plurality of individuals, mutation of mutating part of chromosome information, or a mechanism of selecting an individual on the basis of a given evaluation criterion (see, e.g., Takeshi Agui & Tomoharu Nagao, “Genetic Algorithm”, Shokodo, ISBN4-7856-9046-1 C3055).

FIG. 10 shows an example of the arrangement of the matching candidate output unit 4A. The matching candidate output unit 4A comprises a population holding unit 41, parent individual designation unit 42, crossing-over/mutation processing unit 43, replacement target selection unit 44, and individual replacement unit 45 as functional means for implementing the genetic algorithm.

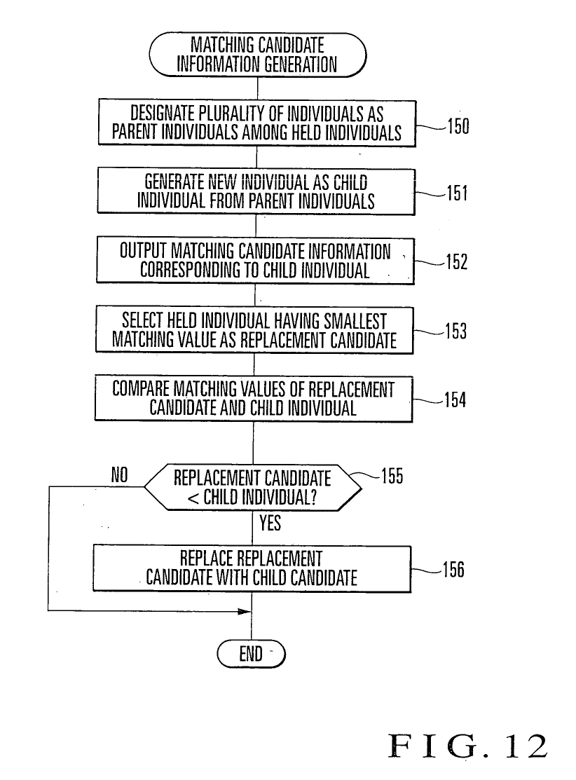

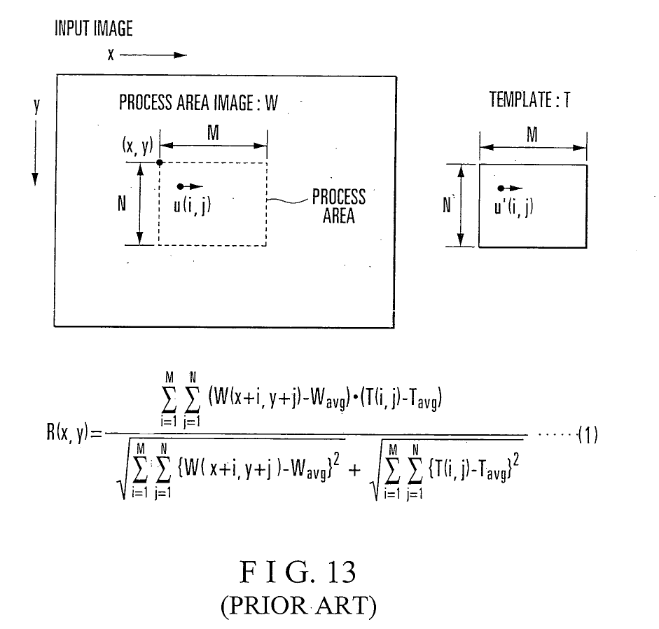

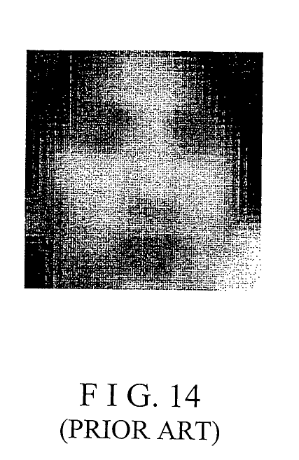

A matching candidate information generation process according to the second embodiment will be explained with reference to FIG. 12.

The population holding unit 41 holds in advance a plurality of individuals having chromosome information containing conversion parameters such as the center position, rotation angle, and enlargement ratio which determine conversion of template data. FIG. 11 shows an example of the structure of an individual (chromosome information). In this example of the structure of an individual 51, an X-coordinate 61 and Y-coordinate 62 representing a center position, a rotation angle θ 63, and an enlargement ratio M 64 are expressed by binary bit strings which are coupled to each other.

The parent individual designation unit 42 generates address information 52 at random, and outputs it to the population holding unit 41, thereby designating, as parent individuals, some of individuals held in advance in the population holding unit 41 (step 150). Instead of generating the address information 52 at random, the address information 52 may be designated in a regular order or selected at a probability corresponding to an evaluation value such as the matching effectiveness of each individual.

The crossing-over/mutation processing unit 43 receives a plurality of individuals 51 selected by the address information 52 from the population holding unit 41, and generates a new individual called a child individual from the parent individuals on the basis of the genetic algorithm such as crossing-over or mutation (step 151). The crossing-over/mutation processing unit 43 outputs a parameter contained in chromosome information of the child individual as the matching candidate information 14 (step 152).

The template coordinate calculation unit 5 converts the template data 13 on the basis of the conversion parameter contained in the matching candidate information 14 from the matching candidate output unit 4A, thereby generating the new template data 15.

The matching calculation unit 6A executes the same matching value calculation process as that described above on the basis of the template data 15, calculates a matching value, and outputs the calculation result 16 to a target area specifying unit 7. The target area specifying unit 7 and a target area information extraction unit 8 perform the same processes as those described above, and obtain desired target area information 18.

The matching calculation unit 6A feeds back an obtained matching value 19 to the matching candidate output unit 4A.

The individual replacement unit 45 of the matching candidate output unit 4A evaluates an individual held in the population holding unit 41 on the basis of the matching value 19 fed back from the matching calculation unit 6A, and replaces the individual with one having a high matching value and matching effectiveness.

The replacement target selection unit 44 selects, as a replacement candidate individual 54 from the individuals 51 held in the population holding unit 41, an individual having the smallest matching value obtained in the use of these individuals, and notifies the individual replacement unit 45 of the replacement candidate individual 54 (step 153). As for the matching values of individuals, matching values with the edge image 11 or a predetermined sample edge image may be calculated in advance by using template data obtained by coordinate transformation based on parameters contained in chromosome information of the individuals.

The individual replacement unit 45 compares the matching value of the replacement candidate individual 54 with the matching value 19 of the fed-back child individual (step 154).

If the matching value 19 of the child individual is larger than the matching value of the replacement candidate individual 54 (YES in step 155), the individual replacement unit 45 outputs a replacement instruction 55 so as to replace the replacement candidate individual 54 with the child individual. In response to this, the population holding unit 41 replaces the replacement candidate individual 54 with the child individual having high matching effectiveness (step 154). As a result, individual selection is done, and a series of matching candidate information generation processes end.

If the matching value of the child individual is not larger than that of the replacement candidate individual 54 (NO in step 155), the child individual having low matching effectiveness is discarded, i.e., selected, and a series of matching candidate information generation processes end.

In general, it is not known which of template data respectively converted by the center position, rotation angle, and enlargement ratio efficiently matches an image extracted from an input image. It is important for shortening the extraction process time to find out a conversion parameter effective for matching as soon as possible.

The second embodiment generates matching candidate information by using the genetic algorithm. A desired conversion parameter can be efficiently found out by evolving an individual effective for matching on the basis of a parent individual selected by the address information 52 from conversion parameters having an enormous number of combinations.

The number of template matching processes necessary to detect a desired extracted image can be greatly reduced, and the extraction process time can be greatly shortened, compared to the use of template data generated by sequentially changing conversion parameters and the use of template data generated on the basis of random conversion parameters.

Of individuals or parent individuals, an individual having the smallest matching value is selected as a replacement candidate. If the matching value of a child individual is larger than that of the replacement candidate, the child individual is held instead of the replacement candidate. The matching values of all individuals or parent individuals can be improved, and an optimal conversion parameter can be found out at higher efficiency.

Note that the individual replacement process is not limited to the above-described process sequence, and may employ another process sequence used in the genetic algorithm. For example, life information of each individual may be added to chromosome information, and the individual may be erased at the end of life. In selecting a parent individual from the population, an individual having a large matching value may be preferentially selected at a probability corresponding to the matching value of the individual.

According to the present invention, the edge position of a target image can be searched for with a template of a very small data amount. In addition, an edge other than that of the target image can be recognized on the basis of negative points, and the target image area can be extracted at high precision.

Compared to the prior art that uses a plurality of templates or a continuous tone image as template data, the process time taken for the matching value calculation process can be greatly shortened, and the storage capacity for holding template data can be greatly reduced. Also, a target image area can be extracted at high precision without any influence of noise.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1. A template matching method of calculating a matching value representing matching between a process area image and a target image by using the process area image in an arbitrary process area acquired from an edge image of an input image and template data representing a shape feature of the target image, and specifying an area of the target image in the input image on the basis of the matching value, the template data being formed from positive points representing positions at which an edge of the target image exists in the process area and negative points representing positions at which no edge exists in the process area, comprising:
the first step of calculating the matching value in accordance with a positional relationship between the positive points, the negative points, and each edge present within the process area image.

2. A method according to claim 1, wherein
the edge image is formed from a plurality of pixels in which edge images contained in the input image are represented by gray values, and
the first step comprises the second step of calculating, for each positive point and each negative point, evaluation values on the basis of gray values of the pixels of the process area image that correspond to positions of the positive point and the negative point, and the third step of calculating the matching value from the evaluation values of the positive point and the negative point.

3. A method according to claim 2, wherein
the second step comprises the step of calculating, as the evaluation value for each positive point, the gray value of the pixel of the process area image that corresponds to the position of the positive point, and the step of calculating, as the evaluation value for each negative point, a value by subtracting, from the number of gray levels of the edge image, the gray value of the pixel of the process area image that corresponds to the position of the negative point, and
the third step comprises the step of calculating the matching value from a sum of the evaluation values calculated in the second step.

4. A method according to claim 1, wherein the first step comprises the fourth step of generating, as matching candidate information, a plurality of types of parameters used for coordinate transformation of the positive points and the negative points of the template data, and the fifth step of transforming coordinates of the positive points and the negative points of the template data on the basis of the matching candidate information and generating new template data used to calculate the matching value.

5. A method according to claim 4, wherein the fourth step comprises the step of holding a plurality of individuals having chromosome information containing the plurality of types of parameters used for coordinate transformation of the positive points and the negative points of the template data, the step of designating as parent individuals a plurality of individuals among the individuals, the step of generating a child individual from the parent individuals on the basis of a genetic algorithm, and the step of outputting as the matching candidate information a parameter contained in chromosome information of the child individual.

6. A method according to claim 5, wherein the fourth step comprises the step of selecting, as a replacement candidate from the held individuals, an individual having the smallest matching value obtained by using new template data generated on the basis of matching candidate information of the individual, and the step of, when the matching value obtained by using new template data generated on the basis of matching candidate information of the child individual is larger than the matching value of the replacement candidate, holding the child individual as a new individual instead of the replacement candidate.

7. A method according to claim 1, wherein the negative points are so arranged as not to overlap another edge of the target image that exists around the edge of the target image.

8. A method according to claim 7, wherein the negative points are arranged within an area formed by the edge of the target image.

9. A method according to claim 7, wherein the negative points are arranged outside an area formed by the edge of the target image.

10. A method according to claim 1, wherein the negative points are arranged along and around a shape formed by an arrangement of the positive points.

11. A method according to claim 1, wherein the positive points are arranged at a density corresponding to a ratio at which the edge of the target image appears in an area where the positive points are arranged.

12. A method according to claim 1, wherein the negative points are arranged at a density corresponding to a ratio at which an edge other than the edge of the target image appears in an area where the negative points are arranged.

13. A method according to claim 1, wherein the target image is formed from a person's face image, and the edge of the target image is formed from an edge representing a lower contour of the person's face image.

14. A method according to claim 1, wherein the template data is formed from face template data having positive points representing positions at which an edge representing a lower contour of a person's face image exists and negative points representing positions at which the edge representing the lower contour of the person's face image does not exist.

15. A method according to claim 14, wherein the edge representing the lower contour of the person's face image uses a semielliptic shape.

16. A method according to claim 14, wherein the positive points are arranged at a high density in a cheek contour area of the person's face image and a low density in a chin contour area of the person's face image.

17. A method according to claim 14, wherein the negative points are arranged at a high density in a cheek contour area of the person's face image in an area outside an area formed by the edge representing the lower contour of the person's face image, and a low density in a chin contour area of the person's face image.

18. A target image area extraction apparatus which specifies an area of a person's face image contained in an input image by using a template matching method defined in claim 1.

19. A target image area extraction apparatus comprising:
an image input unit which generates an edge image representing a contour of an object from an input image;
an image holding unit which holds and stores the edge image;
a template data holding unit which holds and stores template data representing a shape feature of a target image to be extracted;
a matching candidate output unit which generates, as matching candidate information, a plurality of types of parameters used for coordinate transformation of the template data;
a template coordinate calculation unit which performs coordinate transformation for the template data read out from said template data holding unit on the basis of the matching candidate information, and generates new template data;
a matching calculation unit which calculates matching values representing matching between process area images extracted from process areas sequentially set in the edge image of said image holding unit and the template data generated by said template coordinate calculation unit;
a target area specifying unit which, when a matching value obtained from said matching calculation unit exceeds a predetermined reference value, specifying a process area having the matching value as an area containing the target image; and
an area information extraction unit which outputs area information in a target image area on the basis of a coordinate position of the specified process area and the template data,
wherein the template data is formed from positive points representing positions at which an edge of the target image exists in the process area and negative points representing positions at which no edge exists in the process area, and
said template coordinate calculation unit calculates the matching value in accordance with a positional relationship between the positive points, the negative points, and each edge present within the process area image.

20. An apparatus according to claim 19, wherein the edge image is formed from a plurality of pixels in which edge images contained in the input image are represented by gray values, and
said template coordinate calculation unit calculates, for each positive point and each negative point, evaluation values on the basis of gray values of the pixels of the process area image that correspond to positions of the positive point and the negative point, and calculates the matching value from the evaluation values of the positive point and the negative point.

21. An apparatus according to claim 20, wherein said template coordinate calculation unit calculates, as the evaluation value for each positive point, the gray value of the pixel of the process area image that corresponds to the position of the positive point, calculates, as the evaluation value for each negative point, a value by subtracting from the number of gray levels of the edge image the gray value of the pixel of the process area image that corresponds to the position of the negative point, and calculates the matching value from a sum of the evaluation values.

22. An apparatus according to claim 19, wherein said matching candidate output unit comprises
a population holding unit which holds and stores a plurality of individuals having chromosome information containing the plurality of types of parameters used for coordinate transformation of the positive points and the negative points of the template data,
a parent individual designation unit which designates as parent individuals a plurality of individuals among the individuals held in said population holding unit, and
a new individual generation unit which generates a child individual from the parent individuals on the basis of a genetic algorithm, and outputs as the matching candidate information a parameter contained in chromosome information of the child individual.

23. An apparatus according to claim 22, wherein said matching candidate output unit further comprises
means for selecting, as a replacement candidate from the individuals held in said population holding unit, an individual having the smallest matching value obtained by using new template data generated on the basis of matching candidate information of the individual, and
means for, when the matching value obtained by using new template data generated on the basis of matching candidate information of the child individual is larger than the matching value of the replacement candidate, holding the child individual as a new individual instead of the replacement candidate.

24. A method comprising:
(a) calculating a matching value based on a positional relationship between positive points, negative points, and an edge of a target image, the target image to be extracted from a process area image, wherein the positive points represent positions at which the edge exists within a process area, and the negative points represent positions at which the edge does not exist within the process area, wherein template data are derived from the positive points and the negative points and represent a shape feature of the target image, wherein the matching value matches the process area image to the target image by using the process area image in an arbitrary process area, wherein the arbitrary process area is defined by the template data and by an edge image of an input image; and
(b) specifying an area of the target image in the input image on the basis of the matching value.

25. The method of claim 24, wherein the edge image is formed from a plurality of pixels in which edge images contained in the input image are represented by gray values, and wherein the calculating the matching value in (a) comprises:
(c) calculating an evaluation value, for each positive point and each negative point, on the basis of the gray values of the pixels of the process area image that correspond to positions of the positive point and the negative point; and
(d) calculating the matching value using the evaluation value of each positive point and each negative point.

26. The method of claim 25, wherein the calculating the evaluation value in (c) comprises a calculation, for each positive point, of the gray value of the pixel of the process area image that corresponds to the position of the positive point, and a calculation, for each negative point, of a value by subtracting, from the number of gray levels of the edge image, the gray value of the pixel of the process area image that corresponds to the position of the negative point, and wherein the calculating the matching value in (d) uses the evaluation value calculated in (c).

27. The method of claim 24, wherein the calculating the matching value in (a) comprises:
(e) generating, as matching candidate information, a plurality of types of parameters used for coordinate transformation of the positive points and the negative points of the template data; and
(f) transforming coordinates of the positive points and the negative points of the template data on the basis of the matching candidate information, and generating new template data used to calculate the matching value.

28. The method of claim 27, wherein the generating the plurality of types of parameters in (e) comprises:
(g) choosing a plurality of individuals having chromosome information containing the plurality of types of parameters used for coordinate transformation of the positive points and the negative points of the template data;
(h) designating as parent individuals a plurality of individuals among the individuals;
(i) generating a child individual from the parent individuals on the basis of a genetic algorithm; and
(j) outputting, as the matching candidate, information of a parameter contained in chromosome information of the child individual.

29. The method of claim 28, wherein the generating the plurality of types of parameters in (e) comprises:
(k) selecting, as a replacement candidate from the chosen individuals, an individual having the smallest matching value obtained by using new template data generated on the basis of matching candidate information of the individual; and
(l) retaining the child individual as a new individual instead of the replacement candidate when the matching value obtained by using new template data generated on the basis of matching candidate information of the child individual is larger than the matching value of the replacement candidate.

30. The method of claim 24, wherein the negative points are so arranged as not to overlap another edge of the target image that exists around the edge of the target image.

31. The method of claim 30, wherein the negative points are arranged within an area formed by the edge of the target image.

32. The method of claim 30, wherein the negative points are arranged outside an area formed by the edge of the target image.

33. The method of claim 24, wherein the negative points are arranged along and around a shape formed by an arrangement of the positive points.

34. The method of claim 24, wherein the positive points are arranged at a density corresponding to a ratio at which the edge of the target image appears in an area where the positive points are arranged.

35. The method of claim 24, wherein the negative points are arranged at a density corresponding to a ratio at which an edge other than the edge of the target image appears in an area where the negative points are arranged.

36. The method of claim 24, wherein the target image is formed from a person's face image, and the edge of the target image is formed from an edge representing a lower contour of the person's face image.

37. The method of claim 24, wherein the template data are derived from face template data having positive points representing positions at which an edge representing a lower contour of a person's face image exists and negative points representing positions at which the edge representing the lower contour of the person's face image does not exist.

38. The method of claim 37, wherein the edge representing the lower contour of the person's face image uses a semi-elliptical shape.

39. The method of claim 37, wherein the positive points are arranged at a high density in a cheek contour area of the person's face image and at a low density in a chin contour area of the person's face image.

40. The method of claim 37, wherein the negative points are arranged at a high density in a cheek contour area of the person's face image in an area outside an area formed by the edge representing the lower contour of the person's face image, and at a low density in a chin contour area of the person's face image.

41. A target image area extraction apparatus that specifies an area of a person's face image contained in an input image by using the method of claim 24.

42. A device comprising:
a template data holding unit that stores template data representing a shape feature of a target image to be extracted;
a template coordinate calculation unit that performs coordinate transformation on the template data based on matching candidate information and that generates new template data;
a matching calculation unit that calculates a matching value, wherein the matching value matches a process area to the new template data generated by the template coordinate calculation unit;
a target area specifying unit that specifies the process area associated with the matching value as an area containing the target image when the matching value exceeds a predetermined reference value; and
a target area information extraction unit that outputs area information for a target image area based on the new template data and a coordinate position of the specified process area, wherein the new template data are derived from positive points representing positions at which an edge of the target image exists within the process area and negative points representing positions at which no edge of the target image exists within the process area, and wherein the matching calculation unit calculates the matching value based on a positional relationship between the positive points, the negative points, and each edge present within the process area.

43. The device of claim 42, further comprising:
a matching candidate output unit that generates the matching candidate information, wherein the matching candidate information includes a plurality of types of parameters used for coordinate transformation of the template data.

44. The device of claim 42, further comprising:
an image holding unit that stores an edge image representing a contour of an object from an input image, wherein the device extracts process area images from process areas sequentially set in the edge image stores in the image holding unit.

45. The device of claim 44, wherein the edge image is formed from a plurality of pixels in which edge images contained in the input image are represented by gray values, and wherein the template coordinate calculation unit calculates, for each positive point and each negative point, an evaluation value based on a gray value of the pixel of a process area image that corresponds to each positive point and each negative point.

46. The device of claim 45, wherein the template coordinate calculation unit calculates the evaluation value for each negative point by subtracting the gray value of the pixel of the process area image that corresponds to the negative point from the number of gray levels of the edge image.

47. A device comprising:
an image holding unit that stores an edge image representing a contour of an object in an input image; and
means for specifying a process area in the input image as a specified process area that contains a target image and for extracting the target image from the input image.

48. The device of claim 47, wherein the means uses template data to represent the target image.

49. The device of claim 48, wherein the template data are derived from positive points representing positions at which an edge of the target image exists within the process area and negative points representing positions at which no edge of the target image exists within the process area.
